(19) United States
(12) Patent Application Publication
(10) Pub. No.: US 2005/0061302 A1
(43) Pub. Date: Mar. 24, 2005

(54) Purge valve including a permanent magnet linear actuator

(76) Inventors: Corey Tatsu, Chatham (CA); Gilles Amirault, Nova Scotia (CA); Dale Zdravkovic, Mississuaga (CA)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/871,526

(22) Filed: Jun. 21, 2004

Related U.S. Application Data
(60) Provisional application No. 60/480,417, filed on Jun. 20, 2003.

(51) Int. Cl. F02M 33/04

(52) U.S. Cl. 123/520; 251/129.22

(57) ABSTRACT

A valve and method of purging fuel vapors from a fuel vapor collection canister. The purge valve includes an aperture, a member that is displaced between closed and open configurations with respect to the aperture, and an actuator. The actuator, which displaces the member between the configurations, includes an armature and a stator. The armature is coupled to the member, the stator includes a winding, and the actuator includes a permanent magnet. The purge valve may be directly mounted to the intake manifold of an internal combustion engine.

### CROSS REFERENCE TO RELATED APPLICATIONS

This application claims the benefit of the earlier filing date of U.S. Provisional Application No. 60/480,417, filed 20 Jun. 2003, which is incorporated by reference herein in its entirety.

Related co-pending applications filed concurrently herewith are identified as “Purge Valve Including an Annular Permanent Magnet Linear Actuator” (Attorney Docket No. 2003P08979US-01) and “Purge Valve Including a Dual Coil Permanent Magnet Linear Actuator” (Attorney Docket No. 2003P08980US-01), each of which are incorporated by reference herein in their entirety.

### FIELD OF THE INVENTION

This invention is germane to devices including linear actuators. This invention relates generally to on-board emission control systems for internal combustion engine powered motor vehicles, e.g., evaporative emission control systems, and more particularly to a fuel vapor canister purge solenoid valve in an evaporative emission control system.

### BACKGROUND OF THE INVENTION

A known on-board evaporative emission control system includes a canister that collects fuel vapor emitted from a fuel tank containing a volatile liquid fuel for the engine. As the canister collects fuel vapor, the canister progressively becomes more saturated with the fuel vapor. During engine operation, vacuum from the engine intake manifold induces atmospheric airflow through the canister, and draws the collected fuel vapor into the engine intake manifold for consumption in the combustion process. This process is commonly referred to as “purging” the fuel vapor collection canister, and is controlled by a canister purge solenoid valve in response to a purge control signal generated by an engine management system.

### SUMMARY OF THE INVENTION

The present invention provides a purge valve for a fuel system that includes an intake manifold of an internal combustion engine and a fuel tank in vapor communication with a fuel vapor collection canister. The purge valve includes an aperture, a member, and an actuator. The aperture defines a portion of a vapor flow path that extends between first and second ports. The first port communicates vapor with the fuel vapor collection canister, and the second port communicates vapor with the intake manifold. The member is displaced between first and second configurations with respect to the aperture. The member in the first configuration occludes the aperture and vapor flow along the vapor flow path is substantially prevented. The member in the second configuration is spaced from the aperture and vapor flow along the vapor flow path is permitted. The actuator displaces the member between the first and second configurations. The actuator includes an armature and a stator. The armature is coupled to the member and is displaced along an axis. The armature includes a permanent magnet. And the stator includes a winding that at least partially surrounds the permanent magnet.

The present invention provides a purge valve for a fuel system that includes an intake manifold of an internal combustion engine and a fuel tank in vapor communication with a fuel vapor collection canister. The purge valve includes an aperture, a member, and an actuator. The aperture defines a portion of a vapor flow path that extends between first and second ports. The first port communicates vapor with the fuel vapor collection canister, and the second port communicates vapor with the intake manifold. The member is displaced between first and second configurations with respect to the aperture. The member in the first configuration occludes the aperture and vapor flow along the vapor flow path is substantially prevented. The member in the second configuration is spaced from the aperture and vapor flow along the vapor flow path is permitted. The actuator displaces the member between the first and second configurations. The actuator includes an armature and a stator. The armature is coupled to the member and is displaced along an axis. And the stator includes a winding and a permanent magnet.

The present invention also provides a method of purging fuel vapor from a fuel vapor collection canister to an intake manifold of an internal combustion engine. The method includes controlling with a purge valve fuel vapor flow between the fuel vapor collection canister and the intake manifold, the purge valve includes a permanent magnet armature and an electromagnetic stator, and mounting the purge valve on the intake manifold of the internal combustion.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a schematic illustration of a fuel system that includes a fuel vapor canister purge valve in accordance with the detailed description of the preferred embodiment.

FIG. 2 is a cross-sectional view of an actuator for the fuel vapor canister purge valve illustrated in FIG. 1.

FIG. 3 is a graph illustrating the relationship between actuator force and armature displacement for the actuator shown in FIG. 2.

FIG. 4 is a cross sectional view of a first preferred embodiment for the fuel vapor canister purge valve illustrated in FIG. 1.

FIG. 5 is a graph illustrating the relationship between fuel vapor flow and a control signal being applied to the fuel vapor canister purge valve illustrated in FIG. 4.

FIG. 6 is a perspective view of an armature for a second preferred embodiment of the fuel vapor canister purge valve illustrated in FIG. 1.

FIG. 7 is an illustration of a magnetic circuit incorporating the preferred embodiment of the armature shown in FIG. 6.

FIG. 8 is a graph illustrating the relationship between actuator force and armature displacement for an actuator incorporating the preferred embodiment of the armature shown in FIG. 6.

### DETAILED DESCRIPTION OF THE PREFERRED EMBODIMENT

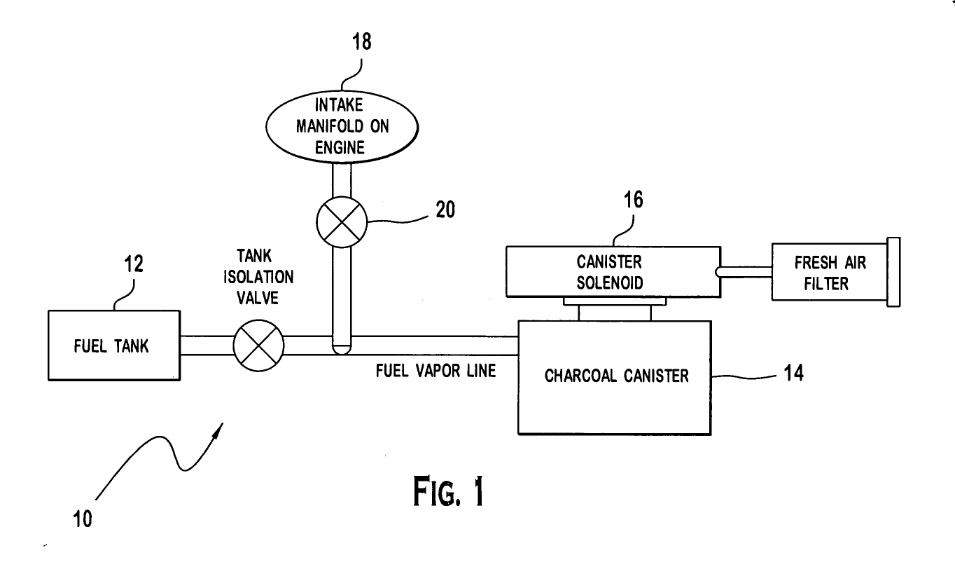

Referring to FIG. 1, a fuel system 10, e.g., for an engine (not shown), includes a fuel tank 12, a fuel vapor collection canister 14 (e.g., a charcoal canister), a canister solenoid valve 16, a vacuum source 18 such as an intake manifold of the engine, and a purge valve 20.

Hydrocarbon fuel vapors from the fuel tank 12 flow through a fuel vapor line connecting the fuel tank 12 and the fuel vapor collection canister 14. These fuel vapors are stored in the fuel vapor collection canister 14, which includes a storage medium, e.g., charcoal, that has a natural affinity for hydrocarbons. During engine operation, the intake manifold vacuum source 18 draws atmospheric air through the canister, via the canister solenoid valve 16, where the air picks up hydrocarbon vapors. These vapors then enter the engine intake manifold where they combine with the fuel-air mixture and are burnt in the engine.

So that the effect on the fuel-air mixture of the additional hydrocarbon vapors can be managed, it is important for a purge valve to precisely meter the fuel vapor flow, and thus it is desirable for the purge valve 20 to respond in a linear manner to control signals from an engine management computer. Thus, it is desirable that an actuator for the purge valve provides a linear relationship between the force it produces and its range of movement. Moreover, it is desirable that the magnitudes of the force and range of the actuator be sufficient for different control signals. An actuator for the purge valve 12 provides a force that allows for a stronger return spring opposing movement of the actuator, and thus provides improved leak resistance when the purge valve 12 is closed and provides improved positional stability during purging. And the range of the actuator provides increased sensitivity to the control signal, and thus provides accurate purging.

Referring now to FIG. 2, there is shown an example of an actuator 100 that includes a stator 120 and an armature 140. The stator 120 includes a winding 122 that is supplied electricity so as to produce magnetic flux. A magnetic circuit for the flux includes a top washer 124, a bottom washer 126, and a shell 128. The top washer 124, the bottom washer 126, and the shell 128 are made of a ferrous material, e.g., steel. The washers 124,126 act as pole pieces that concentrate the magnetic flux, and the shell 128 completes a magnetic circuit that also includes the armature 140.

Preferably, the armature 140 includes a permanent magnet 142 sandwiched between a top armature piece 144 and a bottom armature piece 146. The permanent magnet 142 is preferably a rare earth magnet such as a composition of neodymium, iron and boron that is made by a powder metallurgy process that results, after magnetic alignment and sintering, in oriented metal magnets exhibiting >99% of theoretical density. A sintered construction permits complex geometries while minimizing cost and without sacrificing magnetic strength. Preferably, the permanent magnet 142 has an energy product of at least approximately 32 Mega Gauss Oersted (MGOe), which is believed to provide a suitable balance between cost and energy products. Additional characteristics, such as operating temperature, can be provided by adjusting the metallurgy of the permanent magnet 142. The top and bottom armature pieces 144,146 are made of a ferrous material, e.g., steel. The top armature piece 144 may be particularly shaped so as to provide an appropriate linear force versus travel characteristic in conjunction with the arrangement of the stator 120.

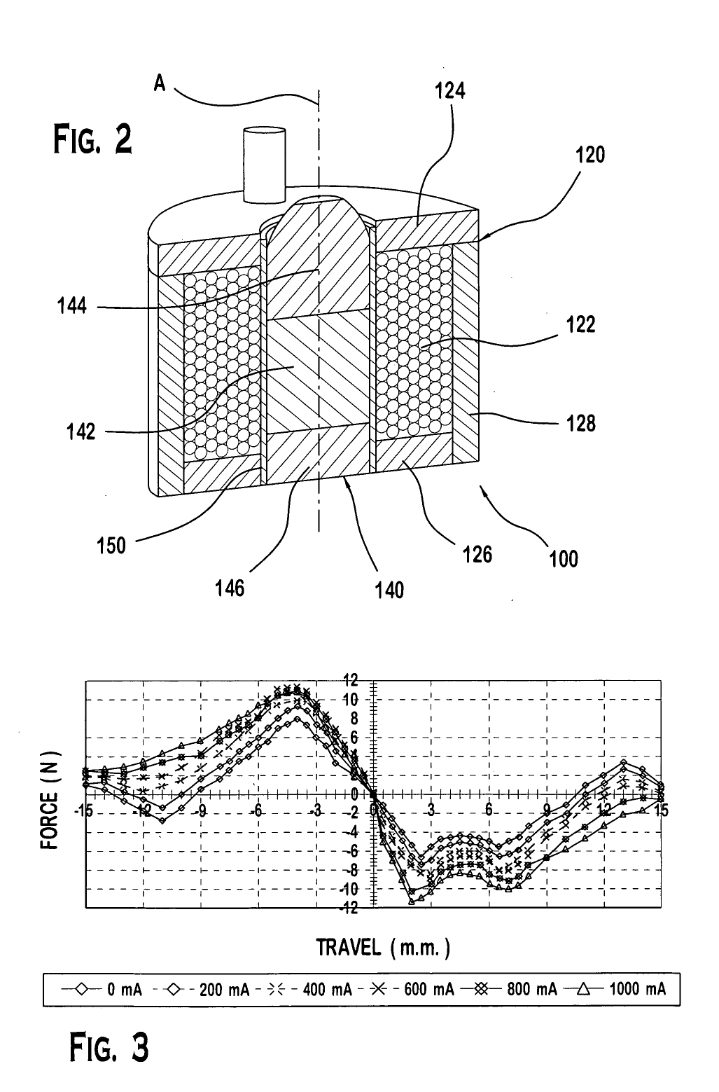

The stator 120 and armature 140, as shown in FIG. 2, may provide force versus travel characteristics as illustrated by the constant current traces shown in FIG. 3. Notably, there are three ranges of suitable linearity that are shown in FIG. 3: 1) from approximately −11 millimeters to approximately −4 millimeters, i.e., a range of approximately 7 millimeters; 2) from approximately −4 millimeters to approximately +2.5 millimeters, i.e., a range of approximately 6.5 millimeters; and 3) from approximately 6.5 millimeters to approximately 13 millimeters, i.e., a range of approximately 6.5 millimeters. In general, it has been found that ranges of approximately 4-5 millimeters are satisfactory for the purge valve 20, however, the larger ranges of linearity that are possible with the actuator 100 may provide improved controllability and stability, e.g., reduced sensitivity to external forces such as vibration and inertial effects.

A sleeve 150 is radially interposed between the stator 120 and the armature 140. The sleeve 150 may provide a guide for the relative movement of the armature 140 with respect to the stator 120, and may align the stator 120 and the armature 140 along a common longitudinal axis A. The sleeve 150 reduces sliding friction while providing a durable guide for the armature 140 and, by virtue of its minimal radial thickness, minimizes the gaps in the magnetic circuit between the stator 120 and the armature 140. Preferably, the sleeve 150 is formed of brass, however, other non-ferrous materials such as stainless steel, Teflon®, or other plastic materials, etc. may be used so long as they also reduce friction, are durable, and minimize the magnetic gap.

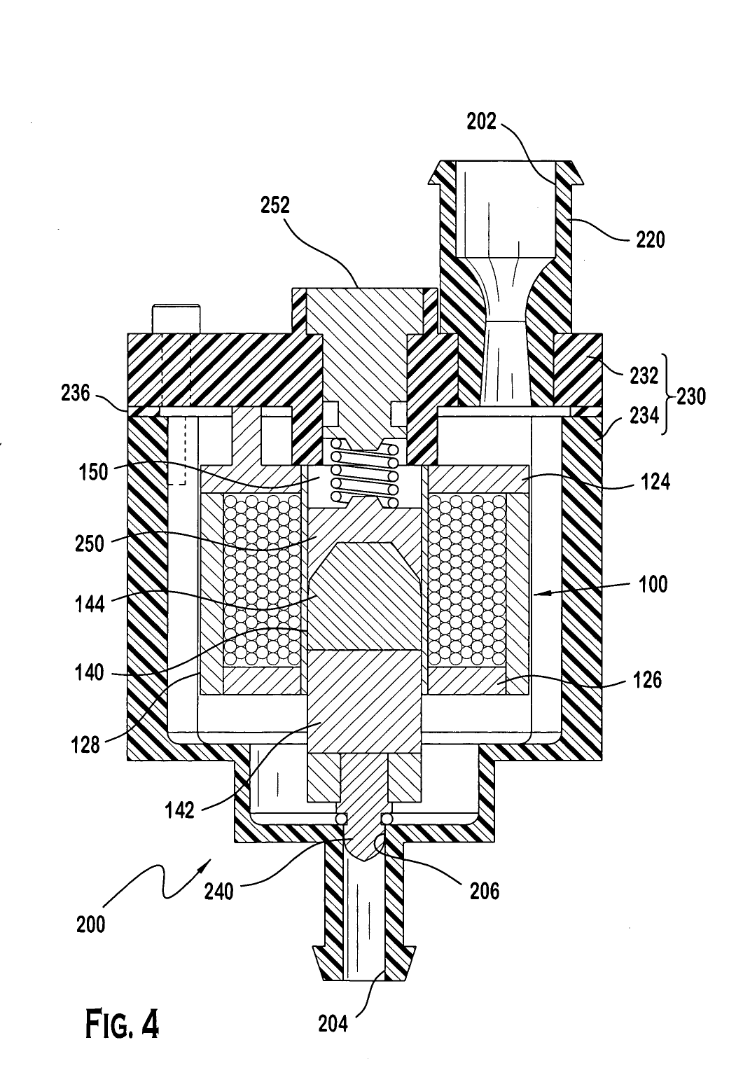

Referring now to FIG. 4, there is shown a preferred embodiment 200 for the fuel vapor canister purge valve 12 shown in FIG. 1. An inlet port 202 communicates fuel vapor from the fuel vapor collection canister 14. A replaceable nozzle 220 may, as shown in FIG. 4, have an internal cross-section profile of a sonic nozzle, and defines the inlet port 202. As it is used here, the term “sonic nozzle” refers to a nozzle geometry that substantially mitigates the effect of varying pressure levels that are drawn by the vacuum source 18. Of course, other profiles are envisioned, including a straight, constant diameter internal diameter.

The replaceable nozzle 220 may be fitted to a housing 230 that defines the exterior of the purge valve 200. As shown in FIG. 4, the housing 230 includes a cap 232, to which the replaceable nozzle 220 is fitted, and a body 234. A seal 236 suitable for contact with fuel vapor may be positioned between the cap 232 and the body 234 to ensure that the connection therebetween is fluid tight. The body 234 also defines an outlet port 204, which communicates fuel vapor to the vacuum source 18, and an aperture 206 through which fuel vapor passes when flowing from the inlet port 202 to the outlet port 204.

A member 240 is displaced between first and second configurations with respect to the aperture 206. The member 240 in the first configuration (as shown in FIG. 4) occludes the aperture 206 and vapor flow along the vapor flow path is substantially prevented, and the member 240 in the second configuration (not shown) is spaced from the aperture 206 and vapor flow along the vapor flow path is permitted. Preferably, the member 240 is a pintle that is received in and occludes the aperture 206 in the first configuration.

As shown in FIG. 4, an actuator 100 as shown in FIG. 2 is positioned in the body 234 of the housing 230. The member 240 is coupled to the armature 140, which displaces the member 240 from the first configuration to the second configuration. According to the present invention, the member 240 may be coupled to the armature 140 solely due to the magnetic attraction of the permanent magnet 142, and the bottom armature piece 146 may surround the member.

The top armature piece 144 may be engaged by a spring holder 250 that provides a seat for a resilient element (not shown), e.g., a coil spring. The resilient element, which may be positioned between the spring holder 250 and the cap 232 of the housing 230, provides a force that biases the armature 140 and the member 240 toward the closed configuration of the purge valve 200. A calibration device 252, e.g., a screw, may provide the opposite seat for the resilient element and may be adjustably positioned with respect to the cap 232 to vary the biasing force of the resilient element.

As it is used in this disclosure, “flow path” refers to the entirety of the passage through which fuel vapor passes through the purge valve 200. Accordingly, in the second or open configuration of the purge valve 200, fuel vapor enters via the inlet port 202, passes through the nozzle 220, passes along one or more flow channels between the body 234 and the shell 128, passes along one or more flow channels between the body 234 and the bottom washer 126, passes around the armature 140, passes through the space between the member 240 and the aperture 206, and exits via the second port 204.

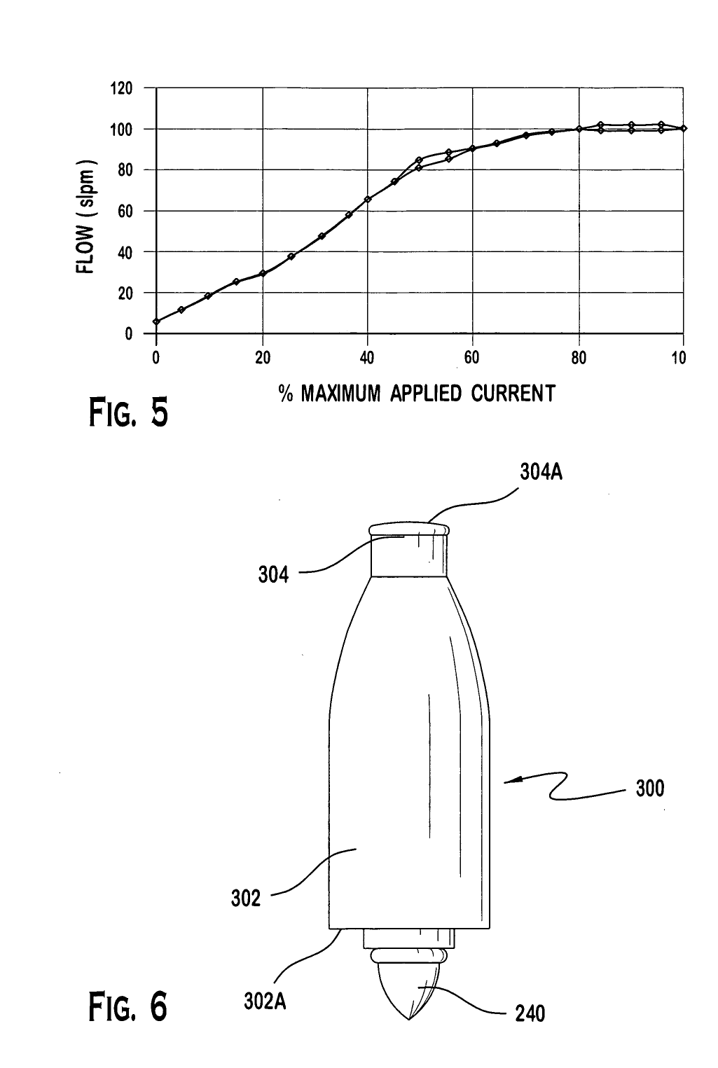

As illustrated by the traces shown in FIG. 5, the purge valve 200 provides the desired generally linear relationship between the flow of fuel vapor and the control signal supplied to the purge valve 200.

Referring now to FIG. 6, there is shown an armature shape that provides desirable magnetic characteristics, e.g., force curves. Having a moving permanent magnet armature may limit the amount and circuit path of flux entering and leaving the armature given that the flux must enter the permanent magnet through its south pole and exit through its north pole. The inventors of the present invention have discovered that the “bottle-like” shape of the armature, moving with respect to a stator 120′ including a permanent magnet 142′, may provide preferred magnetic characteristics. Specifically, it has been determined that a suitable shaped armature 300 has a cylindrical body 302, to which the member 240 is coupled at the bottom and a relatively constricted neck 304. Specifically, the armature 300 extends longitudinally along the axis A from a first end 302A to a second end 304A; the first end 302A has a first transverse cross-sectional area, and the second end 304A has a second transverse cross-sectional area that is smaller than the first transverse cross-sectional area. The armature 300 may be formed from any ferrous material.

The shoulder portion 306 that connects the body 302 and neck 304 has a tapering cross-sectional area with a curving longitudinal profile proximate the body 302 and a generally straight profile proximate the neck 304. Specifically, the rate at which the transverse cross-sectional area of the armature 300 changes from the body 302 to the neck initially increases non-linearly and then increases linearly approaching the neck 304.

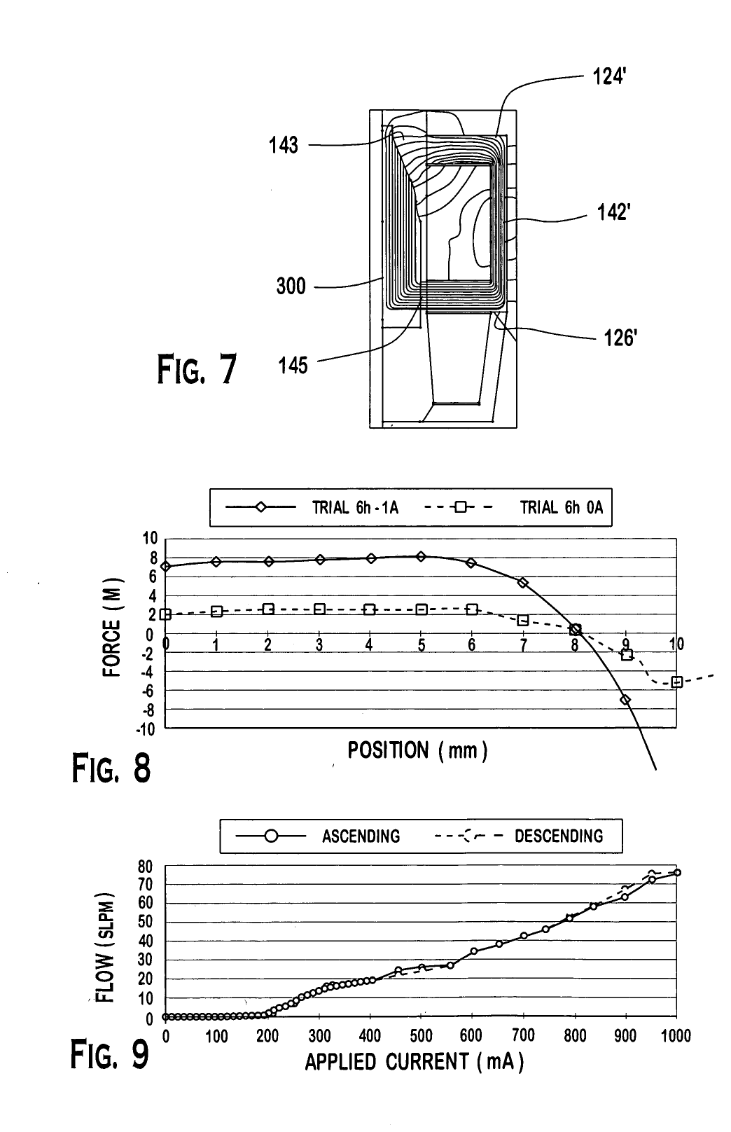

FIG. 7 illustrates the flux lines that occur in a magnetic circuit that includes the stator 120′ and the armature 300. Preferably, the permanent magnet 142′ is shaped like a cylinder and is positioned between and magnetically couples a top pole piece 124′ and a bottom pole piece 126′. Thus, the magnetic circuit as shown in FIG. 7 includes the permanent magnet 142′, the top pole piece 124′, the working magnetic gap 143, the armature 300, the parasitic magnetic gap 145, and the bottom pole piece 126′. Consequently, as shown in FIG. 8, this magnetic circuit produces generally flat force curves, which are advantageous insofar as the magnetic forces that are produced are less sensitive to changes in the longitudinal position of the armature 300 within the stator 120, and the actuator is more stable since there are no steep increases in the force that the actuator applies over its intended operating range. FIG. 9 additionally shows similarly flat force versus longitudinal displacement tracings for different control signals.

The present invention provides a number of advantages. First, the present invention provides a smaller exterior size as compared to known purge valves, particularly linear purge valves having similar actuator force capabilities. Second, a purge valve according to the present invention can now be mounted directly to the intake manifold of an engine, which in turn enables the engine control unit to employ a simpler algorithm to control the purge valve, as well as reduces cost by eliminating mounting brackets, hoses, hose connections, etc. This is believed to be in part due to reducing the lag time between fuel vapor flow being initiated, i.e., the purge valve opening, and when the fuel reaches the intake manifold. Known linear purge valves could not be mounted directly to the intake manifold because vibration of the engine would unseat the valves, thereby causing unintended purging, and would cause unintended valve movement during purging, thereby causing flow ripples that reduce flow controllability. Third, a purge valve according to the present invention avoids stacking-up of manufacturing tolerance variations and may be controlled by simpler algorithms, as compared to known linear purge valves. Fourth, a brass sleeve according to the present invention is positioned between the stator and the armature to provide central alignment during assembly, guide the relative movement between the armature and the stator, and reduce hysteresis, particularly in the direction of armature travel.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

1. A purge valve for a fuel system including an intake manifold of an internal combustion engine and a fuel tank in vapor communication with a fuel vapor collection canister, the purge valve comprising:
an aperture defining a portion of a vapor flow path extending between first and second ports, the first port communicates vapor with the fuel vapor collection canister, and the second port communicates vapor with the intake manifold;
a member being displaced between first and second configurations with respect to the aperture, the member in the first configuration occludes the aperture and vapor flow along the vapor flow path is substantially prevented, and the member in the second configuration is spaced from the aperture and vapor flow along the vapor flow path is permitted; and
an actuator displacing the member between the first and second configurations, the actuator including:
an armature being coupled to the member and being displaced along an axis, the armature including a permanent magnet; and
a stator including a winding a least partially surrounding the permanent magnet.

2. The purge valve according to claim 1, wherein an electrical current being supplied to the winding displaces the armature along the axis, which displaces the member to the second configuration.

3. The purge valve according to claim 1, wherein at least one of the first and second ports comprises a sonic nozzle.

4. The purge valve according to claim 1, wherein the member comprises a pintle that is received in and occludes the aperture in the first configuration.

5. The purge valve according to claim 1, wherein the vapor flow path extends from the first port, around the stator, through the aperture when the member is in the second configuration, to the second port.

6. The purge valve according to claim 1, wherein the actuator comprises a housing that is relatively fixed with respect to the stator.

7. The purge valve according to claim 6, wherein the actuator comprises a resilient member extending between the armature and the housing, and the resilient member applies a force biasing the armature toward the first configuration.

8. The purge valve according to claim 7, wherein the actuator comprises an adjuster varying the force applied by the resilient member.

9. The purge valve according to claim 7, wherein the actuator comprises a holder interposed between the resilient member and the armature.

10. The purge valve according to claim 9, wherein the holder is non-magnetic.

11. The purge valve according to claim 6, wherein the member in the first configuration is magnetically attracted to the housing.

12. The purge valve according to claim 6, wherein the housing defines at least one of the aperture, the first port, and the second port.

13. The purge valve according to claim 1, wherein the permanent magnet is magnetically coupled to the member.

14. The purge valve according to claim 13, wherein the permanent magnet is mechanically coupled to the member.

15. The purge valve according to claim 1, wherein the armature comprises first and second ferrous armature pieces located at respective axial ends of the permanent magnet.

16. The purge valve according to claim 1, wherein the stator comprises first and second ferrous pole pieces located at respective axial ends of the winding.

17. The purge valve according to claim 16, wherein the stator comprises a ferrous shell extending longitudinally along the axis and surrounding the winding, the ferrous shell magnetically couples the first and second ferrous pole pieces.

18. The purge valve according to claim 16, wherein the stator comprises a sleeve extending longitudinally along the axis and being located radially between the winding and the armature, the sleeve mechanically couples the first and second ferrous pole pieces.

19. The purge valve according to claim 18, wherein the sleeve comprises brass.

20. The purge valve according to claim 18, wherein the winding is contiguously engaged on the sleeve.

21. The purge valve according to claim 18, wherein the sleeve comprises a guide aligning the armature relative to the stator.

22. A purge valve for a fuel system including an intake manifold of an internal combustion engine and a fuel tank in vapor communication with a fuel vapor collection canister, the purge valve comprising:
an aperture defining a portion of a vapor flow path extending between first and second ports, the first port communicates vapor with the fuel vapor collection canister, and the second port communicates vapor with the intake manifold;
a member being displaced between first and second configurations with respect to the aperture, the member in the first configuration occludes the aperture and vapor flow along the vapor flow path is substantially prevented, and the member in the second configuration is spaced from the aperture and vapor flow along the vapor flow path is permitted; and
an actuator displacing the member between the first and second configurations, the actuator including:
an armature being coupled to the member and being displaced along an axis; and
a stator including a winding and a permanent magnet.

23. The purge valve according to claim 22, wherein the armature extends along the axis from a first end proximate the member to a second end distal from the member, the first end having a first transverse cross-sectional area, and the second end having a second transverse cross-sectional area smaller than the first transverse cross-sectional area.

24. The purge valve according to claim 23, comprising a rate at which a transverse cross-sectional area of the armature changes from the first to the second transverse cross-sectional areas, the rate increases non-linearly from the first transverse cross-sectional area and increases linearly approaching the second transverse cross-sectional area.

25. The purge valve according to claim 23, wherein the armature comprises at least one rib surrounding the axis and projecting radially outward from the axis.

26. A method of purging fuel vapor from a fuel vapor collection canister to an intake manifold of an internal combustion engine, the method comprising:
controlling with a purge valve fuel vapor flow between the fuel vapor collection canister and the intake manifold, the purge valve including a permanent magnet armature and an electromagnetic stator; and
mounting the purge valve on the intake manifold of the internal combustion.
